(19) United States
(12) Patent Application Publication
(10) Pub. No.: US 2009/0217342 A1
(43) Pub. Date: Aug. 27, 2009

(54) Parental Control for Social Networking

(76) Inventor: Sima Nadler, Kochav Yair (IL)

Correspondence Address: IBM CORPORATION, T.J. WATSON RESEARCH CENTER, P.O. BOX 218, YORKTOWN HEIGHTS, NY, 10598, US

(21) Appl. No.: 12/036,296

(22) Filed: Feb. 25, 2008

(51) Int. Cl. G06F 17/00

(52) U.S. Cl. 726/1

(57) ABSTRACT

A computer-implemented infrastructure is provided for use with social communication services that are accessed via the public Internet. Facilities of the infrastructure identify a controlled class of users and permit a supervisory class of users to monitor and control use of social communication services server by the controlled class. The infrastructure enables children to access social communication services servers, and allows their parents to supervise their use of such services on an ongoing basis.

### BACKGROUND OF THE INVENTION

1. Field of the Invention

This invention relates to network communication. More particularly, this invention relates to supervision of computer-mediated social networking activities.

2. Description of the Related Art

Internet access has now become ubiquitous, and has created a risk of unauthorized disclosure of private information via interaction with web sites. Additionally, uncontrolled access to the Internet risks inflow of undesirable information. More recently, the popularity of social networking web sites has created a further risk of endangerment from social contacts deemed inimical and even predatory. Children are considered a particularly vulnerable class in this regard. In the work environment, an employer may desire to protect his interests by limiting or supervising Internet access by employees.

Attempts have been made to block Internet access or limit it to approved sites. For example, in the patent document WO 00/67096 it is proposed to provide a completely self-contained internet exclusively for children or other private groups. An address space of content loaded onto the system may be partitioned for individual children or members and may be increased by authenticated, verified consent by parents or system administrators. The system provides hardware and means for authorizing the addition of requested web pages onto the system.

U.S. Pat. No. 6,785,824 proposes a supervisory scheme wherein an adult intervenes during a child's interaction with the Internet using a character facade. The arrangement requires a registration website and a character website. A processor operates with a program to receive a message from a child user, notifies an adult user of the received message via electronic mail, receives a reply from the adult user, and presents the reply to the child user as though coming from a character rather than the adult user. Various measures of security are implemented. For instance, both the adult and child users must enter some type of login, password, or other type of serial identification, which is checked against valid identifications, to obtain access to the registration and character web sites.

In the field of supervising electronic commerce, U.S. Patent Application Publication No. 2003/0061111 proposes creating and sending a notifying e-mail message to an authorizing party's e-mail address that describes a proposed e-transaction and solicits the authorizing party's review and disposition of the proposed e-transaction. The notifying e-mail to the authorizing party describing the proposed e-transaction may also provide information to assist the authorizing party in disposing of the proposed e-transaction, e.g., a description of the goods or services sought by the proposing party, details identifying the source of the goods or services, the cost, and historical data pertaining to cost and descriptions of proposed or consummated e-transactions by the proposing party.

### SUMMARY OF THE INVENTION

An embodiment of the invention provides a computer-implemented method of controlling social networking activities, which is carried out by establishing respective accounts for a supervisory individual and a supervised individual with an identity manager, the accounts including social networking identities. A supervisory social networking identity is assigned to the supervisory individual and a supervised social networking identity to the supervised individual. The social networking identities encode a control relationship of the supervisory individual to the supervised individual. The method is further carried out by maintaining a set of rules that are designated by the supervisory individual, and which regulate interactions of the supervised individual with a social communication services server. The method is further carried out by recognizing a proposed interaction between the supervised individual and the social communication services server via a public Internet, wherein the proposed interaction triggers one of the rules, deriving the supervisory social networking identity from the supervised social networking identity, communicating a message informing the supervisory individual of the proposed interaction, the supervisory individual being identified from the derived supervisory social networking identity, receiving a response to the message from the supervisory individual, and permitting the proposed interaction when the response is an approval thereof, and denying the proposed interaction when the response is a rejection thereof.

According to one aspect of the method, the proposed interaction includes registration by the supervised individual with the social communication services server.

According to another aspect of the method, the proposed interaction includes a transfer of pre-designated information between the supervised individual and the social communication services server.

According to a further aspect of the method, the proposed interaction includes establishment of a social contact with a client of the social communication services server.

According to yet another aspect of the method, the set of rules is maintained by the identity manager.

According to yet another aspect of the method, the set of rules is maintained by the social communication services server.

Still another aspect of the method communicating a message and receiving a response are performed by the identity manager, and permitting and denying the proposed interaction are effected by communicating the response from the identity manager to the social communication services server.

Still another aspect of the method communicating a message, receiving a response, permitting and denying are performed by the social communication services server.

A further aspect of the method includes maintaining a trust rating of the supervised individual in the identity manager that is accessible to supervisors of other supervised individuals.

An additional aspect of the method includes maintaining a ranking service wherein evaluations of the supervision of the supervised individual by the supervisory individual are received from other supervisory individuals.

One aspect of the method includes maintaining a log of interactions with the social communication services server by the supervised individual.

An aspect of the method includes automatically limiting exchange of predefined content between a client operated by the supervised individual and the social communication services server.

Other embodiments of the invention provide computer software product and apparatus for carrying out the above-described method.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 pictorially illustrates a networked data processing system for interaction with social networking sites in accordance with a disclosed embodiment of the invention;

FIG. 2 is a block diagram of a credential system for use in interaction with social communication services in accordance with a disclosed embodiment of the invention;

FIG. 3 is a flow chart of a method of parental control of registration with a social networking web site in accordance with a disclosed embodiment of the invention;

FIG. 4 is a flow chart of a method of parental supervision of a child's activities on a social networking web site in accordance with a disclosed embodiment of the invention;

FIG. 5 is a sequence diagram of a use case in accordance with a disclosed embodiment of the invention; and

FIG. 6 is a block diagram of a credential system for use in interaction with social communication services in accordance with an alternate embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client/server environment, such software programming code may be stored on a client or a server. The software programming code may be embodied on any of a variety of known tangible media for use with a data processing system, such as a diskette, or hard drive, or CD-ROM. The code may be distributed on such media, or may be distributed to users from the memory or storage of one computer system over a network of some type to storage devices on other computer systems for use by users of such other systems.

### Overview.

According to disclosed embodiments of the invention, an infrastructure is provided that facilitates controlled interaction with many computer-implemented social communication services, e.g., social networking web sites, chat and social messaging servers, blog sites, RSS (Really Simple Syndication) feeds, and servers providing virtual reality environments (virtual worlds). All of these modalities facilitate the organization and operations of on-line communities that are generally based on some common interest. Social communication services enable such online communities to exchange information, post events, and collaborate on joint objectives. To control exposure of a protected or controlled class to on-line communities, the infrastructure registers controlled and supervisory classes of clients. It permits the supervisory class to monitor and control use of the social communication services by the controlled class. Parents and children constitute a paradigm of supervisory and controlled classes, which is presented herein by way of example and not of limitation.

Aspects of the invention enable children to access social networking web sites that employ the infrastructure, yet allow their parents to supervise their use of these sites. Other aspects of the invention provide parents with tools to supervise the use of social networking web sites that lack the infrastructure.

### System Architecture.

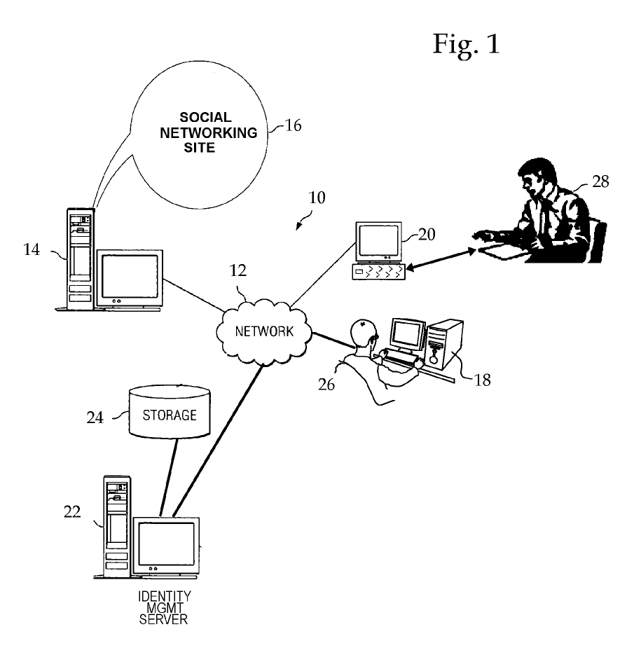

Turning now to the drawings, reference is initially made to FIG. 1, which pictorially illustrates a networked data processing system 10 to which the principles of the invention are applied. The system 10 involves a public network 12, which is a medium used to provide communications links between various devices and computers or other communications devices connected together within the system 10. The network 12 may include connections, such as wire, wireless communication links, or fiberoptic cables. The system 10 is not meant as an architectural limitation. Rather, the principles of the invention are applicable to many types of networks and configurations of computers and servers.

In the depicted example, the network 12 is the Internet, and represents a worldwide collection of networks and gateways that use the Transmission Control Protocol/Internet Protocol (TCP/IP) suite of protocols to communicate with one another. Alternatively, the system 10 may be implemented with a number of different types of networks and sub-networks in many combinations, for example, an intranet, a local area network (LAN), or a wide area network (WAN).

A social networking server 14, is connected to the network 12. The social networking server 14 hosts an exemplary web site, e.g., a social networking web site 16 that is used by a client 18. For purposes of explication, a social networking web site is presented as a representative application for the social networking server 14. However, the social networking server 14 may additionally or alternatively host the other above-noted social communication services in many combinations, it being understood that such web sites and other services may be distributed among many servers.

In addition, any number of clients of the social networking server 14, shown representatively in FIG. 1 as clients 18, 20, are connected to the network 12. The clients may be implemented by such devices as personal computers, network terminals, personal digital assistants (PDA's) or cellular telephones. In any case, the clients 18, 20 are provided with suitable memory for executing program instructions that support the functions and activities detailed below.

Also connected to the network 12 is an identity management server 22 that is linked to a storage unit 24 for holding data of supervisory individuals and supervised individuals, shown in FIG. 1 as clients 18, 20, respectively. The storage unit 24, shown here as a remote unit, may alternatively be integral with the identity management server 22. It typically holds data concerning the supervisory individuals and supervised individuals that are necessary for the function of the social networking web site 16 and the identity management server 22. Many such services are commonly provided by social networking web sites. For example, the social networking server 14 may provide an instant messaging service to facilitate the exchange of messages between its users via the hosted social networking web site. Such services may be mediated by the identity management server 22 as described in further detail below.

The identity management server 22 may be operated by the entity controlling the social networking web site 16 and/or the social networking server 14. In some embodiments, the identity management server 22, and the social networking server 14 may be integral. Alternatively, the identity management server 22, the social networking server 14 and the social networking web site 16 may be operated by independent entities in various combinations. In the depicted example, the identity management server 22 may provide data, such as boot files, operating system images, and applications to the clients 18, 20.

The clients 18, 20, may be regarded as being operated by members of a controlled class and a supervisory class, respectively. Thus, according to the paradigm, the client 18 is operated by a child 26 desiring to interact with the social networking web site 16, and the client 20 by a parent 28 wishing to exert supervisory control over the activities of the child 26 in respect of the social networking web site 16. It should be noted that the operation of the social networking server 14 under the infrastructure described below with respect to the child 26 and the parent 28 are not dependent on the particular clients 18, 20. The child 26 and the parent 28 may utilize the social networking server 14 and benefit from the operation of the identity management server 22 concurrently or non-concurrently via the same or different client devices, or may access the social networking server 14 using any suitable device for accessing the network 12.

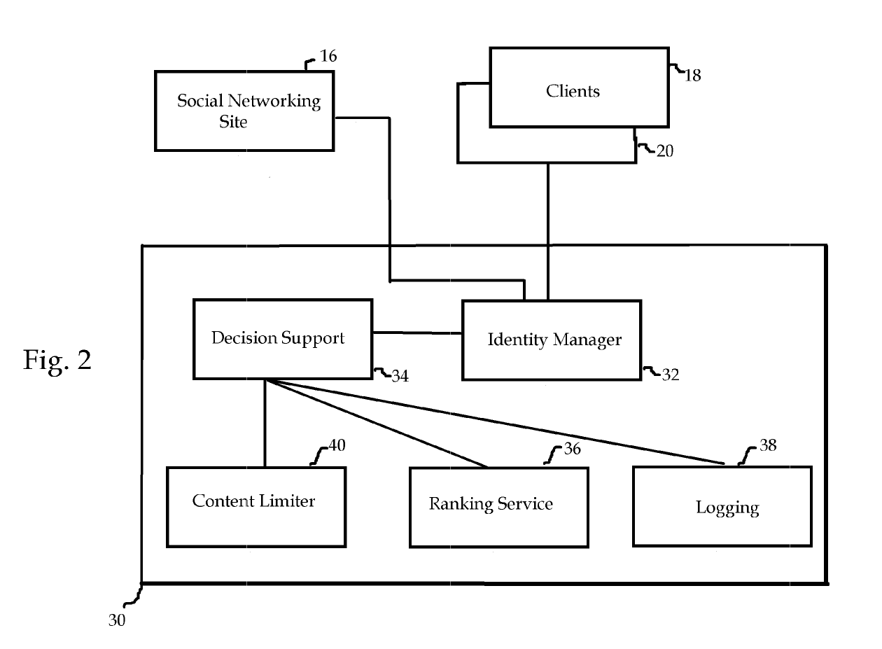

Reference is now made to FIG. 2, which is a block diagram of a credential system 30 that implements an infrastructure that supports parental control of social networking in accordance with a disclosed embodiment of the invention. Components of the credential system 30 typically comprise one or more general purpose or embedded computer processors, which are programmed with suitable software for carrying out the functions described hereinbelow. While portions of the credential system 30 are shown as comprising a number of separate functional blocks, these blocks are not necessarily separate physical entities, but rather represent different computing tasks or data objects stored in a memory that is accessible to the processors. These tasks may be carried out in software running on a single processor, or on multiple processors. For example, in the system 10 (FIG. 1), the software may be distributed in many combinations among the social networking server 14, identity management server 22, and the clients 18, 20 on tangible media, such as CD-ROM or non-volatile memory. Alternatively or additionally, the credential system 30 may be implemented in whole or in part using a digital signal processor or hard-wired logic.

The credential system 30 is an anonymous credential system, also known as a pseudonym system. In one embodiment, it is based on the system known as “idemix”, developed by the assignee hereof, which is disclosed on the Internet at the web site of the IBM Zürich Research Laboratory and in the document, Identity Management and its Support of Multilateral Security, S. Clauβ et al., Computer Networks 37:205-219 (2001), which is herein incorporated by reference. The credential system 30 serves both users and organizations. In particular, the credential system 30 is adapted to serve social networking web sites and the classes that are represented respectively by the child 26 and parent 28 (FIG. 1). The social networking web site 16 and others of its users generally know the child 26 and parent 28 only by pseudonyms.

Using the storage unit 24 (FIG. 1), the credential system 30 provides a repository for the storage of personal data, affording applications the option of eliminating their own storage of such data. The credential system 30 provides a uniform interface for different social networking web sites and other web sites that with which clients may interact.

A key element of the credential system 30 is an identity manager 32. The identity manager 32 maintains a registry of juvenile users of social networking sites and their parents. It regulates the disclosure of personal data during communication across the Internet. During client registration, the identity manager 32 registers personal data, and may track and optionally authorize disclosure of the data during subsequent activities of the juvenile users on the network.

In the field of social networking, the identity manager 32 manages people's identities rather than their credit card or bank account information. It enables an individual to present a fictitious name or alias to the social networking web site, yet assures the site that he has been authenticated by a reliable authority. The identity manager 32 is versatile in that an individual is issued a unique social networking identity, but may associate many fictitious names with his social networking identity for use in different situations. In order to enable social networking web sites to process social networking identities, a specialized application programming interface (API) is provided for their use. Included in the API are functions to approve a supervised client's registration (ApproveRegistration), approve a new contact (ApproveNewFriend), approve upload of contact by a supervised client (ApproveContentUpload), etc.

### Social Networking Identity.

The identity manager 32 maintains a per-client registry of social networking identities, which include pseudonymous communication identifiers. The identity manager 32 supports cryptographic transmission of such pseudonyms and identifiers. Additionally, the identity manager 32 may issue authentication certificates linked to one or more pseudonyms of the clients. Under the idemix-based system, different pseudonyms of the same user cannot be linked. If desired, certificates issued by entities other than the credential system 30 can be used. In either case, by communicating a certificate, a child can establish his authority to engage in a desired activity on a social networking web site pseudonymously, without revealing his actual identity.

Communication between the credential system 30, social networking web sites and clients of the social networking web sites normally involves information exchange using known secure protocols. The protocol used is not critical, so long as it is agreed upon by the parties.

Typically, but not necessarily a child's social networking identity, is derived in some way from that of the parent, thus encoding a relationship between the two. The social networking identities of the parent and child are sometimes referred to herein as a “supervisory social networking identity” and a “supervised social networking identity”, respectively. Many identification schemes are suitable, it only being necessary that the social networking identities be unique. For example, The social networking identities of the parent 28 and child 26 could have the following respective forms:

nnnnnnn-mmmmm-0xx,

nnnnnnn-mmxyz-1zz,

wherein the sub-identifier nnnnnnn is a unique designator of a family to which the child 26 and parent 28 belong. The subidentifier mmmmm encode characteristics of interest, e.g., demographics. In this exemplary scheme, the right-most subidentifier begins with the number “0”. This number encodes a supervisory class. The sequence “xx” is a signature that identifies the particular parent 28. In the case of the child 26, the sub-identifier nnnnnnn is identical to that of the parent 28, as both belong to the same family. The sub-identifier mmxyz encodes characteristics of the child 26, which are not necessarily identical to those of the parent 28, and in the sub-identifier 1zz, the number 1 encodes the fact that the child 26 is in a controlled class. The sequence “zz” is the child's signature within the family. Many such schemes are possible. Typically, the social networking identity of the parent 28 incorporates or encodes confidential information including the name and contact method for contacting the parent. The social networking identity of the child 26 normally does not reveal personal identification credentials. Such restrictions may be relaxed or tightened in situations according to security requirements of a particular environment.

### Disclosure Rules.

A decision support module 34 is closely coordinated with the identity manager 32. The identity manager 32 invokes the decision support module 34 in order to disclose a client's data according to criteria specified by the supervisory class, e.g., The parent 28 (FIG. 1) may configure supervisory rules or parameters for use by the decision support module 34. Such rules may be individualized for each child being supervised.

Table 1 illustrates an exemplary partial set of supervisory rules relating to social networking activities of a child that may be designated by the parent.

TABLE 1

| | Parental |
|---|---|
| | Permission |
| Activity | Required |
| Site Registration | Yes |
| Add New Contact | Yes |
| Queries to Contact's Parental SNI | No |
| Review of uploaded material | No |
| Child's Activity Reports at Site | Yes |
| Provide Identity to Parent of Contact | Yes |
| Disclosure of Designated Information | Yes |

The social networking identity of a supervised individual can be provided with a trust rating that indicates whether an individual is highly trusted or not. Subcodes may be introduced in the social networking identity to describe, for example past activities of the supervised individual, e.g., downloading of inappropriate material, impersonations, and impermissible contacts. The trust rating is principally established by the supervisory individual, i.e., a parent. Optionally, the identity manager may supplement the trust rating based on its monitor of the child's activities. The social networking identity can incorporate a code indicating the degree of parental supervision being exercised. In the child-parent paradigm, for example, the trust rating of a child is an important source of information to other families, in which parents are responsible to decide whether to allow their children to interact with that particular child.

Many other supervisory parameters will occur to those skilled in the art. Additions, deletions, and permission modifications of the set are allowed, and indeed may be desirable as characteristics of the site change with time or as the child matures. Thus portions of a social networking identity need not be entirely static, but can be re-encoded as experience dictates.

The credential system 30 incorporates a parent ranking service 36. The ranking service 36 should not be controlled by the social networking web site. It may be realized as an independent ranking server, or may be under control of the identity manager 32 as shown in FIG. 2. The degree and intensity of supervision that a parent intends to exercise over a child's use of a social networking web site may vary considerably. In order to provide information about the quality and intensity of a person's supervision, a ranking service is provided. Using this service, parents can provide feedback about their satisfaction with other parents' supervision of their respective children.

A social network use logging module 38 logs general information about a child's use of the social networking web sites to which he is registered. For example, data such as time spent on sites, and individuals with whom the child interacted may be captured and logged.

Using the services of a content limiter 40 a parent can indicate specific information that is forbidden to be published by the child. Typical examples of information required to be kept confidential are name, address, and telephone number. The content limiter 40 is coordinated with the identity manager 32. When a social networking web site receives content from the child, it compares it to the information provided by the parent via identity manager 32 to ensure that sensitive information is not shared by the child. The content limiter may also reference the identity manager 32 and the decision support module 34 to control information allowed to be downloaded from the social networking web site to the child. Operation.

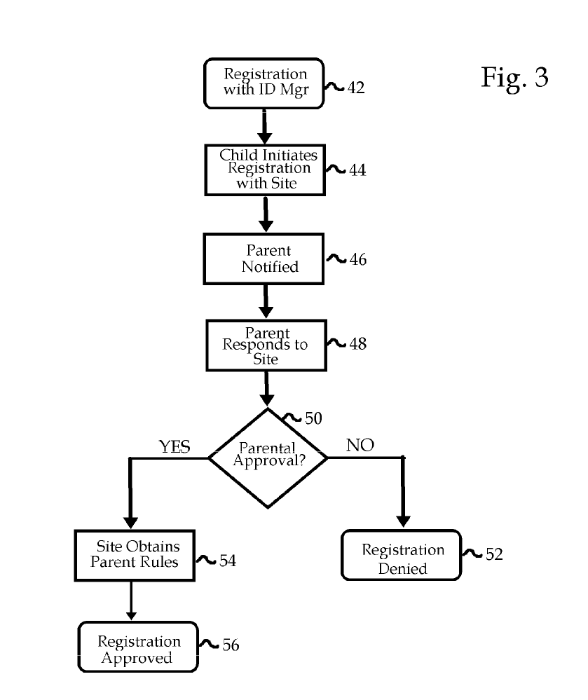

Reference is now made to FIG. 3, which is a flow chart of a method of parental control of registration with a social networking web site in accordance with a disclosed embodiment of the invention. The method may be applied without limitation to other above-noted social communication services. At initial step 42 a social networking web site of interest, a child and a parent register with an identity manager. It is anticipated that many social networking web sites will become registered in order to induce parents to permit their children to interact with the sites. The child and parent each receive a social networking identity. The parent configures a set of supervisory rules and criteria. A registered social networking web site also receives a social networking identity. This is mainly for internal use of the identity manager but also provides parents with information about the site that may assist them in determining whether to permit interactions between the site and their children.

Next, at step 44 a supervised child accesses a data network, e.g., the Internet, contacts a social networking web site and initiates registration with the site by providing his social networking identity to the social networking web site.

Next, at step 46 the social networking web site or the identity manager derives the parent's social networking identity from the social networking identity of the child, and uses the parent's social networking identity to notify the parent, for example by an email, requesting permission for the child to join the site.

Next, at step 48, the parent responds to the message sent in step 46. He may use information included in the message about the site, the client that is the subject of the request, and optionally the ranking service in order to come to a decision.

Control now proceeds to decision step 50, where it is determined if the parent has approved the child's request to register with the social networking web site. If the determination at decision step 50 is negative, then control proceeds to final step 52. The child's request is denied.

If the determination at decision step 50 is affirmative, then control proceeds to step 54. The social networking web site queries the identity manager, and obtains the appropriate supervisory configuration that was established by the parent for activities of the child on social networking web sites of the category to which the particular site belongs. This site's category is generally encoded in its social networking identity.

Next, at final step 56, the child's request to register is approved by the site. The child may now interact with the site, subject to conditions in the supervisory configuration. The child's interactions with the site may optionally be monitored by the identity manager, which then approves or disapproves predefined interactions, e.g., establishment of new contacts, downloads. Alternatively, the identity manager may distribute software to the social networking web site, and the social networking web site may itself undertake the responsibility of monitoring the child's activities. The child's activities are logged by the identity manager. Additionally or alternatively, the site may maintain an activity log.

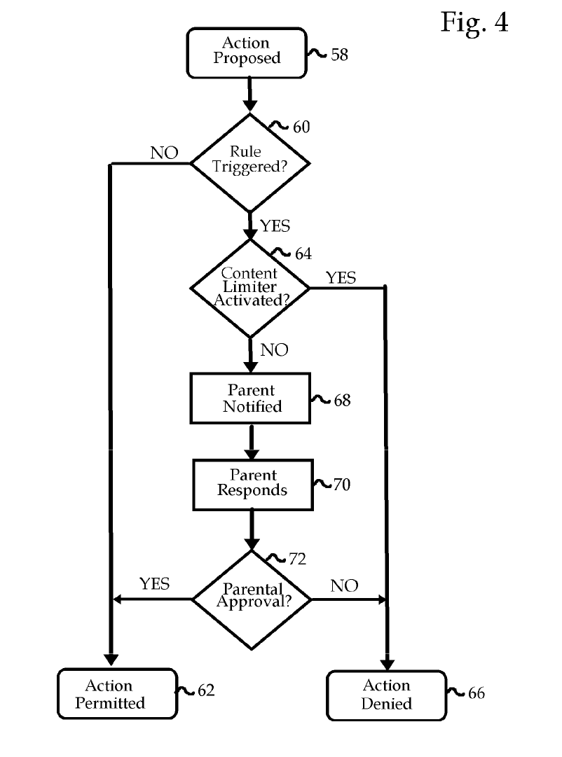

Reference is now made to FIG. 4, which is a flow chart of a method of parental supervision of a child's activities on a social networking web site in accordance with a disclosed embodiment of the invention. It is assumed that the method described with respect to FIG. 3 has been performed, and that the child is duly registered with a social networking web site. At initial step 58, the child contacts the site and initiates a proposed action, for example a request to upload or download a file, or to establish a new social contact.

Control now proceeds to decision step 60, where it is determined if the proposed action triggers a rule that was configured by the parent during the registration process. Decision step 60 may be performed by the identity manager or the social networking web site. If the former, communications are exchanged between the site and identity manager to effect the determination. If the determination at decision step 60 is negative, then control proceeds to final step 62. The operation simply proceeds without further intervention by the social networking web site or parent.

If the determination at decision step 60 is affirmative, then control proceeds to decision step 64. The proposed action is automatically evaluated by a content limiter, which takes into account the type of content that is allowed to be exchanged between the social networking web site and the child based on the supervisory configuration that was established by the parent. It is now determined if the content is prohibited. If so, the content limiter is activated to prevent the exchange.

If the determination at decision step 64 is affirmative, then control proceeds to final step 66. The proposed action is denied.

If the determination at decision step 64 is negative, then control proceeds to step 68. The social networking web site or the identity manager electronically notifies the parent, requesting authorization to permit the proposed action.

Next, at step 70, the parent responds to the message sent in step 68.

Control now proceeds to decision step 72, where it is determined if the parent has approved the proposed action.

If the determination at decision step 72 is affirmative, then control proceeds to final step 62. The child's proposed action is approved.

If the determination at decision step 72 is negative, then control proceeds to final step 66. The child's proposed action is denied. The approval and denial in final step 62 and final step 66 may be executed by the social networking web site.

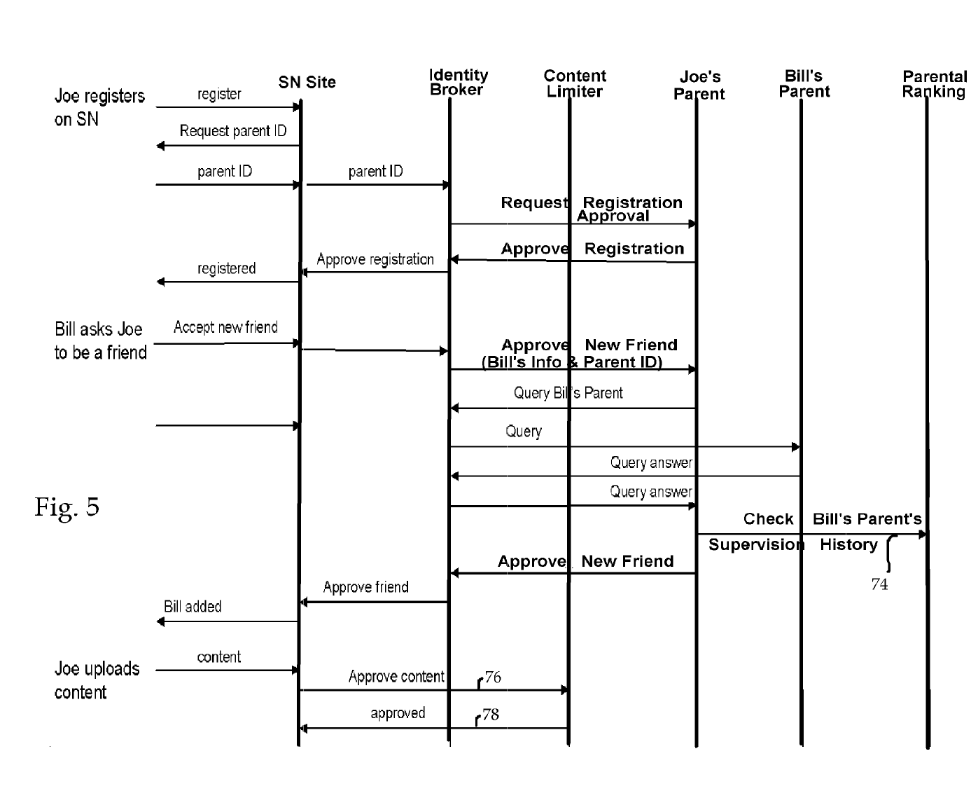

Reference is now made to FIG. 5, which is a sequence diagram of a representative use case in accordance with a disclosed embodiment of the invention. The use case demonstrates the procedures described above with respect to FIG. 3 and FIG. 4. In addition, the use case illustrates the use of parental ranking illustrated by a line 74. It will be recalled that the ranking service provides historical information relating to proposed actions of a child, which may be maintained by an identity manager or an independent ranking entity. The ranking service is consulted by a parent prior to approval of a requested action by a supervised child. The use case further illustrates the operation of a content limiter in lines 76, 78, in which requested content is automatically approved based on rules supplied by the parent, thereby avoiding the burden of manual parental review and authorization.

### Alternative Embodiment.

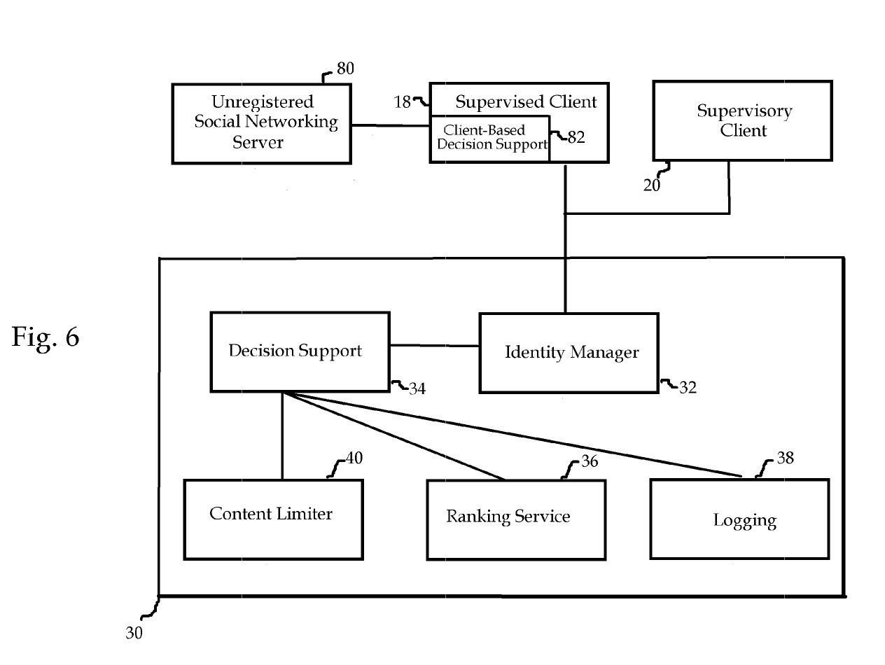

Reference is now made to FIG. 6, which is a block diagram of credential system 30 that is shown in an alternative mode of operation, in accordance with an alternative embodiment of the invention. In this embodiment, client 18 (the supervised individual), has encountered a social communication service with which he wishes to interact. However, the service is hosted by an unregistered social networking server 80 that is not cooperating with the identity manager 32. This event invokes a client-based decision support module 82. The decision support module 82 may be permanently resident in the client 18 or may be obtained as necessary from the credential system 30, for example using an applet or downloading the module on demand. Alternatively, the decision support module 82 could be configured as a plugin for a browser (not shown) that executes in the client 18. In this situation, the decision support module 82 monitors the proposed interaction, and may optionally access the database of the identity manager 32. Should parental approval be required, as described above, the decision support module 82 would block the proposed interaction pending such approval.

While the unregistered social networking web site 80 cannot relate to the credential system 30, nevertheless the parent, client 20, may. In the event another individual associated with the unregistered social networking web site 80, e.g., a proposed contact, has been registered with the credential system 30, the parent may query its facilities, particularly the ranking service 36 to assist his determination of whether to approve the proposed interaction. For example, the parent, client 20, could initiate contact with the parent of the proposed contact using their respective social networking identities.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method of controlling social networking activities, comprising the steps of:
establishing an account for a supervisory individual and a supervised individual with an identity manager, said account comprising social networking identities including a supervisory social networking identity for said supervisory individual and a supervised social networking identity for said supervised individual, said social networking identities encoding a control relationship of said supervisory individual to said supervised individual;
maintaining a set of rules that are designated by said supervisory individual, said rules regulating interactions of said supervised individual with a social communication services server;
recognizing a proposed interaction between said supervised individual and said social communication services server via a public Internet, wherein said proposed interaction triggers one of said rules;
deriving said supervisory social networking identity from said supervised social networking identity;
communicating a message informing said supervisory individual of said proposed interaction, using said derived supervisory social networking identity to identify said supervisory individual;
receiving a response to said message from said supervisory individual; and
permitting said proposed interaction when said response is an approval thereof and denying said proposed interaction when said response is a rejection thereof.

2. The method according to claim 1, wherein said proposed interaction comprises a registration by said supervised individual with said social communication services server.

3. The method according to claim 1, wherein said proposed interaction comprises a transfer of pre-designated information between said supervised individual and said social communication services server.

4. The method according to claim 1, wherein said proposed interaction comprises establishment of a social contact with a client of said social communication services server.

5. The method according to claim 1, wherein said set of rules is maintained by said identity manager.

6. The method according to claim 1, wherein said set of rules is maintained by said social communication services server.

7. The method according to claim 1, wherein said steps of communicating a message and receiving a response are performed by said identity manager, and said steps of permitting and denying comprise communicating said response from said identity manager to said social communication services server.

8. The method according to claim 1, wherein said steps of communicating a message, receiving a response, permitting and denying are performed by said social communication services server.

9. The method according to claim 1, further comprising the step of maintaining a trust rating of said supervised individual in said identity manager that is accessible to supervisors of other supervised individuals.

10. The method according to claim 1, further comprising the step of maintaining a ranking service wherein evaluations of a supervision of said supervised individual by said supervisory individual are received from other supervisory individuals.

11. The method according to claim 1, further comprising the steps of maintaining a log of interactions with said social communication services server by said supervised individual.

12. The method according to claim 1, further comprising the step of automatically limiting exchange of predefined content between a client operated by said supervised individual and said social communication services server.

13. A computer software product for controlling social networking activities, including a tangible computer storage medium in which computer program instructions are stored, which instructions, when executed by a computer, cause the computer to establish an account for a supervisory individual and a supervised individual with an identity manager, said account comprising social networking identities including a supervisory social networking identity for said supervisory individual and a supervised social networking identity for said supervised individual, said social networking identities encoding a control relationship of said supervisory individual to said supervised individual, maintain a set of rules that are designated by said supervisory individual, said rules regulating interactions of said supervised individual with a social communication services server, recognize a proposed interaction between said supervised individual and said social communication services server via a public Internet, wherein said proposed interaction triggers one of said rules, and wherein said supervised individual is identified by said supervised social networking identity, derive said supervisory social networking identity from said supervised social networking identity, communicate a message informing said supervisory individual of said proposed interaction, using said derived supervisory social networking identity to identify said supervisory individual, receive a response to said message from said supervisory individual, and permit said proposed interaction when said response is an approval thereof and deny said proposed interaction when said response is a rejection thereof.

14. The computer software product according to claim 13, wherein said proposed interaction comprises a registration by said supervised individual with said social communication services server.

15. The computer software product according to claim 13, wherein said proposed interaction comprises a transfer of predesignated information between said supervised individual and said social communication services server.

16. The computer software product according to claim 13, wherein said proposed interaction comprises establishment of a social contact with a client of said social communication services server.

17. The computer software product according to claim 13, wherein said computer is further instructed to maintain a trust rating of said supervised individual in said identity manager that is accessible to supervisors of other supervised individuals.

18. The computer software product according to claim 13, wherein said computer is further instructed to maintain a ranking service wherein evaluations of a supervision of said supervised individual by said supervisory individual are received from other supervisory individuals.

19. The computer software product according to claim 13, wherein said computer is further instructed to maintain a log of interactions with said social communication services server by said supervised individual.

20. The computer software product according to claim 13, wherein said computer is further instructed to automatically limit exchange of predefined content between said supervised individual and said social communication services server.

21. A data processing system for controlling social networking activities, comprising:
a processor;
a communications interface to a public Internet; and
a memory accessible to said processor and having instructions resident therein for instructing said processor, said processor and said memory cooperative to establish an account for a supervisory individual and a supervised individual with an identity manager, said account comprising social networking identities including a supervisory social networking identity for said supervisory individual and a supervised social networking identity for said supervised individual, said social networking identities encoding a control relationship of said supervisory individual to said supervised individual, maintain a set of rules that are designated by said supervisory individual, said rules regulating interactions of said supervised individual with a social communication services server, recognize a proposed interaction between said supervised individual and said social communication services server via said public Internet, wherein said proposed interaction triggers one of said rules, and wherein said supervised individual is identified by said supervised social networking identity, derive said supervisory social networking identity from said supervised social networking identity, communicate a message informing said supervisory individual of said proposed interaction, using said derived supervisory social networking identity to identify said supervisory individual, receive a response to said message from said supervisory individual via said communications interface, and permit said proposed interaction when said response is an approval thereof and deny said proposed interaction when said response is a rejection thereof.

22. The data processing system according to claim 21, wherein said proposed interaction comprises a registration by said supervised individual with said social communication services server.

23. The data processing system according to claim 21, wherein said proposed interaction comprises a transfer of predesignated information between said supervised individual and said social communication services server.

24. The data processing system according to claim 21, wherein said proposed interaction comprises establishment of a social contact with a client of said social communication services server.

25. The data processing system according to claim 21, wherein said processor and said memory are cooperative to maintain a trust rating of said supervised individual in said identity manager that is accessible to supervisors of other supervised individuals.

26. The data processing system according to claim 21, wherein said processor and said memory are cooperative to maintain a ranking service wherein evaluations of a supervision of said supervised individual by said supervisory individual are received from other supervisory individuals.

27. The data processing system according to claim 21, wherein said processor and said memory are cooperative to maintain a log of interactions with said social communication services server by said supervised individual.

28. The data processing system according to claim 21, wherein said processor and said memory are cooperative to automatically limit exchange of predefined content between said supervised individual and said social communication services server.
